(19) United States
(12) Patent Application Publication
(10) Pub. No.: US 2016/0369110 A1
(43) Pub. Date: Dec. 22, 2016

(54) Surface Coating For Dissipating Electrical Charge On Anti-Static Installations And Process

(71) Applicant: SIEMENS AKTIENGESELLSCHAFT, München (DE)

(72) Inventors: Juergen Huber, Erlangen (DE); Steffen Lang, Hallerndorf (DE); Bastian Plochmann, Neustadt an der Aisch (DE)

(73) Assignee: SIEMENS AKTIENGESELLSCHAFT, Muenchen (DE)

(21) Appl. No.: 14/901,486

(22) PCT Filed: May 27, 2014
(86) PCT No.: PCT/EP2014/060961

§ 371 Date: Dec. 28, 2015

(30) Foreign Application Priority Data
Jun. 28, 2013 (DE) 10 2013 212 737.5
Aug. 8, 2013 (DE) 10 2013 215 713.4

(51) Int. Cl. C09D 5/24; B64D 45/02; F03D 80/30; C03C 4/14

(52) U.S. Cl. CPC C09D 5/24; C03C 4/14; B64D 45/02; F03D 80/30

(57) ABSTRACT

A surface coating for lightning protection is embodied as a composite material including a matrix formed from a polysilazane or of a polysiloxane, and filled with lamellar, ceramic particles having an electrically conductive coating of metal oxide. The surface coating may be applied to a blade of a wind turbine by applying the conductive coating in liquid form to the blade, allowing the surface coating to harden at room temperature, and pyrolyzing the surface coating via short periods at temperatures up to 700° C. to form a glassy, electrically conductive coating that is resistant to temperature changes.

### CROSS-REFERENCE TO RELATED APPLICATIONS

This application is a U.S. National Stage Application of International Application No. PCT/EP2014/060961 filed May 27, 2014, which designates the United States of America, and claims priority to DE Application No. 10 2013 212 737.5 filed Jun. 28, 2013 and DE Application No. 10 2013 215 713.4 filed Aug. 8, 2013, the contents of which are hereby incorporated by reference in their entirety.

### TECHNICAL FIELD

The invention relates to a surface coating formed of a composite material.

### BACKGROUND

A nonstatic industrial installation, such as a wind turbine, for example, may experience great problems as a result of a lightning strike. Given that wind power installations are usually erected at exposed locations, which frequently constitute the highest point within a larger territory, there are particular considerations which apply here. Since the highest point of a vertical wind turbine turning on a mast at great height at any given time is the tip of a rotor blade, the entry region for the lightning will be situated on one of the rotor blades. The very high current density in lightning must therefore be conducted downward through the rotor. Accordingly, in the event of an incoming lightning strike, the rotor blade, owing to the internal resistance of the materials used, suffers typical lightning damage, manifested in the form of fire, overheating of the individual components, and temperature-related mechanical deformation.

In existing wind power installations, conventional metallic conductor tracks either are mounted completely on the outer skin of the rotor blade, or they run within the rotor blade, with only the end emerging from the rotor blade at its tip. Another form of lightning protection is realized by the introduction of a metallic mesh into a topcoat layer over the entire length of the rotor blade. The result locally is a metallic structure which takes resultant currents and voltages to ground through a connection to the base stand of the wind power installation.

In FIG. 2, by way of example, a rotor blade in three different versions is provided with lightning protection devices.

The individual rotor blades here, from left to right, have different measures for lightning protection. The rotor blade on the left in FIG. 2 includes an electrical conductor which runs beneath the surface and which emerges physically at the tip of the rotor blade. The same is true of the middle rotor blade, in contrast to which the left rotor blade in the vicinity of the top end of its electrical conductor is formed partly as a mesh.

For the grounding of the rotor blade, the rotor blade lying on the right in FIG. 2 has a metal lattice which extends along the entire blade.

### SUMMARY

One embodiment provides a surface coating for lightning conduction, represented by an electrically conductive composite material which comprises a matrix made of a polymer, and a filler made of lamellar ceramic particles, wherein the lamellar ceramic particles are provided with an electrically conductive, metal-oxide coating.

In a further embodiment, the lamellar ceramic particles comprise mica.

In a further embodiment, the electrically conductive, metal-oxide coating of the lamellar ceramic particles comprises a metal-oxide coating which exhibits a nonlinear profile of the electrical resistance as a function of the electrical field strength.

In a further embodiment, the electrically conductive metal-oxide coating comprises an antimony doped tin oxide layer, Sb:SnO2.

In a further embodiment, the antimony doped tin oxide layer, Sb:SnO2, has a high electrical resistance at small field strengths and a very much smaller electrical resistance at large field strengths.

In a further embodiment, the antimony doped tin oxide layer on the lamellar ceramic particles are filled with at least 10 mol % of antimony Sb.

In a further embodiment, the filler comprises a mixture of particles which are ceramic in each case and are provided with an antimony doped tin oxide layer and are of lamellar and/or spherical formation.

In a further embodiment, the matrix is prepared from a polysilazane or from a polysiloxane.

In a further embodiment, organic fractions are eliminated by pyrolysis and with the polysilazane matrix a stable SiN framework being present, or with the polysiloxane matrix a stable SiO₂ framework.

Another embodiment comprises a process for preparing a surface coating as disclose above, wherein the conductive surface coating comprising solvent, is applied in liquid form, and cured, and pyrolysis of the surface coating is performed at short temperature intervals with temperatures up to 700° C., to give a glasslike, temperature-stable, electrically conductive surface coating.

In a further embodiment, the antimony doped tin oxide layer of the lamellar ceramic particles is filled with at least 10 mol % of antimony Sb.

Another embodiment provides the use of any of surface coatings disclosed above for lightning protection on nonmetallic rotor blades of a wind power installation.

Another embodiment provides the use of any of surface coatings disclosed above for lightning protection on nonmetallic surface regions of an aircraft.

Another embodiment provides the use of any of surface coatings disclosed above for lightning protection on carbon fiber-reinforced components.

Another embodiment provides the use of any of surface coatings disclosed above for lightning protection on components made of fiber-reinforced plastic.

### BRIEF DESCRIPTION OF THE DRAWINGS

Example embodiments are described in detail below with reference to the figures, in which:

FIG. 1 shows a diagram on which the resistivity 1 of the surface coating is plotted against the field strength 2,

FIG. 2 shows lightning protection devices on different rotor blades 11 of wind power installations, in accordance with the prior art,

FIG. 3 shows the polarization effect on exposed static objects,

FIG. 4 shows a diagram in which a surface coating undergoes vitrification on pyrolysis,

FIG. 5 shows a micrograph depicting highly conductive, antimony doped tin oxide filler particles present on a mica substrate, and

FIG. 6 shows, in line with FIG. 5, highly conductive tin oxide filler particles, comprising a mixture of lamellar substrate and globular substrate.

### DETAILED DESCRIPTION

Embodiments of the invention provide a lightning protection means for nonstatic installations, such as a wind power installation or an aircraft, for example, to provide components, such as rotor blades on wind power installations, for example, with sufficient lightning protection to conduct away the potential difference that occurs and, accordingly, to reduce or minimize existing problems in relation to fire prevention or severe thermal loading.

Aspects of the invention are based on the finding that the difference in potential that occurs in the case of lightning can be dissipated over the entire surface of an installation without an excessive current density causing severe damage to the installation, by means of a surface coating on those moving areas —particularly areas moving within air—of an installation, with a temperature-stable composite material filled with highly conductive particles.

A layer of composite material as a surface coating is described, including or consisting of a polymer, particularly a polysilazane or polysiloxane, which is filled with a filler composed of lamellar ceramic particles (14) having an electrically conductive, metal-oxide coating. This antimony tin oxide (Sb:SnO2) or antimony-doped tin oxide layer is advantageously applied to mica flakes and doped with antimony, to give electrical conductivity.

For a coating on rotor blades it is advantageous for the application of the composite material to be flexible. Experimentally, a number of organic matrices are already employed in spraying methods as layers of composite material, and hence such product groups can be employed for functional coating of a curved surface, and in principle a complete rotor wing can be coated via spray application.

The coating is a composite material with a ceramic filler composed of a lamellar substrate such as mica, for example, and also of an electrically conductive, metal-oxide coating, such as antimony tin oxide, for example.

Employed advantageously as matrix are substances which cure at room temperature or low temperature, such as polysiloxane or polysilazane.

Further advantages are attainable if a surface coating is pyrolyzed at low moderate temperature. This is done in order to increase further the conductivity of the existing layer.

Filler materials which can be used with preference are metal particles or metal oxide particles with very good conductivity.

The shape of the filler particles may vary—between globular and lamellar, for example. In the case of globular fillers, a very high degree of volume fill, of up to 50 vol %, for example, is necessary, whereas in the case of lamellar filler a stable electrical conductivity is established at a lower level of volume fill, of 25 vol %, for example.

This is called percolation threshold. Mixtures of the aforesaid examples are possible.

It is advantageous to utilize an easy-to-apply coating material, which preferably has good sprayability, so that electrically highly conductive microparticles can be applied thereby as a filling on prefabricated components, and rotor blades of wind power installations, for example, can be easily coated and contacted.

A substantial advantage arises as a result of the partial conductivity of the coating. There is no polarization effect, which would contribute to lightning events. Accordingly, the probability of an incoming lightning strike recedes with this procedure.

In the event of a lightning strike, on the other hand, the high field strength which accompanies the strike results in very high conductivity of the coating and hence in effective conduction of charge through this coating.

The fact of the surface-covering coating of the entire component provides a very high cross-sectional area for the conduction of high electrical currents and voltages. In the case of an incoming lightning strike, accordingly, there is no dangerous excessive temperature increase in the coating as a result of local currents, and there is no degeneration of the polymer layers beneath or overheating of the electrical components.

Particular advantages arise if the partially conductive surface coating at small field strengths has a substantially higher resistance than, for example, metallic conductors impregnated as a mesh into the wind power installations for the purpose of conducting lightning. Accordingly there is no strong polarization effect, which could contribute to the development of a flash discharge.

Consequently, the likelihood of an incoming lightning strike is reduced.

In the course of storms, considerable space charges arise. In addition, within a charged storm cloud, there may be further charge separation mechanisms. If a lightning bolt is triggered, a potential equalization occurs. This is manifested either in intracloud lightning, in other words within the cloud, or in a cloud-to-ground lightning, i.e., between the Earth and the lower portion of the cloud. For lightning bolts between the clouds and the Earth, the potential difference must amount to several 10 000 000 V. In the air, an electrical spark discharge only occurs at an electrical field strength of around 3 000 000 V/m, corresponding to what is called the breakdown field strength.

However, this value decreases significantly with increasing air humidity. To date, however, no such field strengths have been measured in a storm cloud. Measurements only extremely rarely produce field strengths of more than 200 000 V/m. This figure is well below the breakdown field strength value. It is nowadays assumed that the air must first be made conductive by ionization so that a lightning discharge can occur.

The current flowing to ground, at existing resistances, evokes a voltage drop and hence a potential gradient around the strike point. The strike of a lightning bolt corresponds to the connection of a current circuit which is fed with impressed current from an energy source.

The field strength under consideration is generally that built up by the flash discharge and the difference in potential that arises at the lightning strike location.

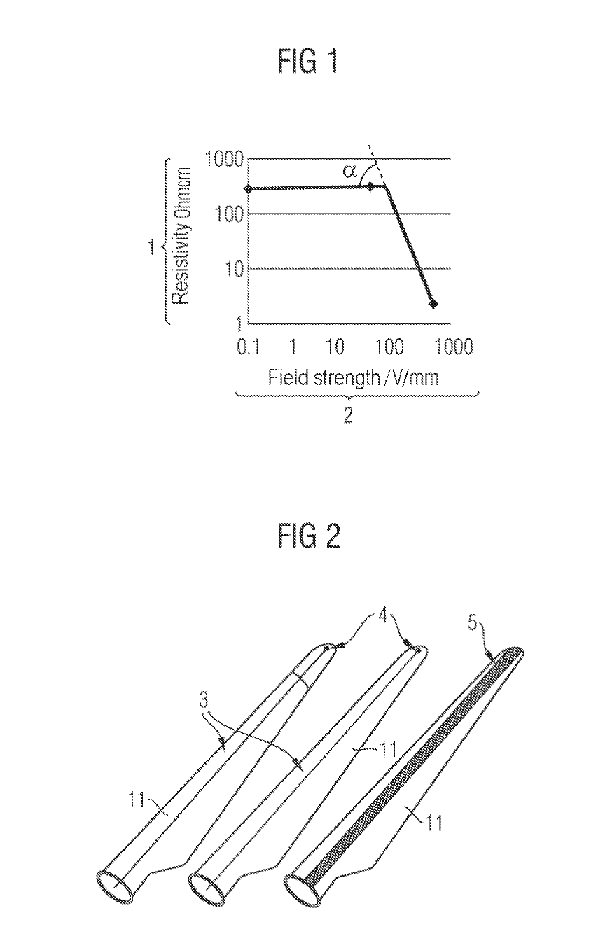

FIG. 1 shows a resistance/field strength diagram, which relates to a surface coating including or consisting of a composite material having a 25 vol % filling including or consisting of lamellar antimony tin oxide/Sb:SnO2. The diagram shows a nonlinear profile of the resistivity with increasing field strength. At low field strengths the resistance is high, and at high field strengths there is a very low resistance.

FIG. 2 shows prior art in the form of rotor blades 11 of a wind power installation. Here, different forms of lightning conduction are in use. In the left-hand rotor blade 11 and in the rotor blade 11 shown in the middle, an internal conductor 3 is drawn, with its end point 4 coming to the surface at the outermost end of a rotor blade 11. In the rotor blade shown on the left in FIG. 2, the inner conductor 3 in the end region is shown partially as a mesh.

The rotor blade 11 shown on the right in FIG. 2 has a metallic mesh 5 which is incorporated preferably into a topcoat layer on the surface of the rotor blade. As a result, locally, a metallic structure is formed which grounds arising currents and voltages through a connection to the base stand of the wind power installation.

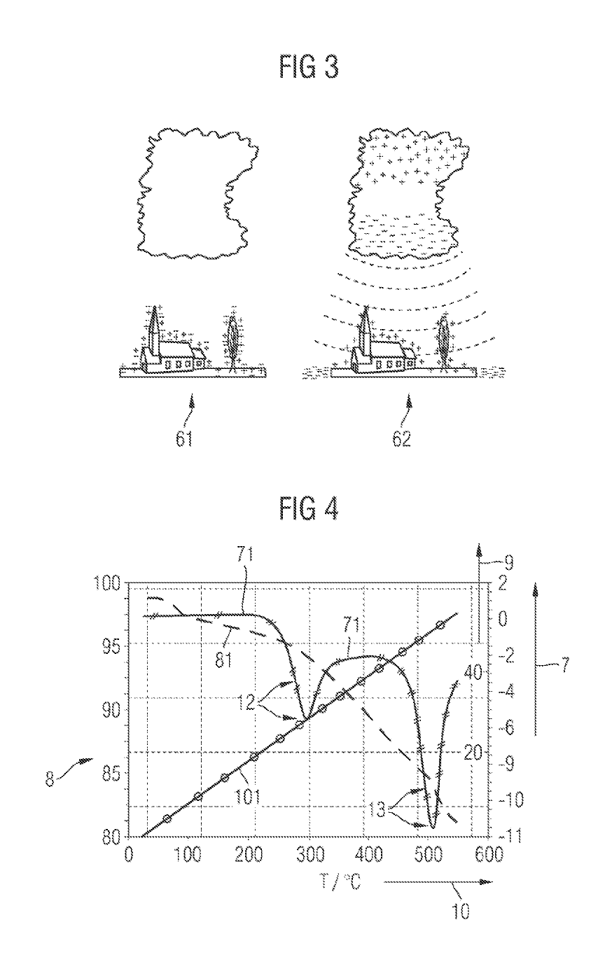

FIG. 3 shows in the left-hand portion a scene on the surface of the Earth, with buildings and a storm cloud, where there is no polarization, and also a scene in which there is polarization 62, a lightning strike having taken place from a charged storm cloud toward the Earth.

Lamellar ceramic fillers have a number of advantages over purely spherical particles:
they have an early percolation threshold which is in some cases below 20 vol %, depending on a form factor,
they lead to a lengthening of the erosion channel through the composite material,
as a result of the high form factor, length/diameter >30, they have very slow sedimentation behavior in processing, as for example on spray application,
as a result of the lightweight support material and also the low initial mass of filler, the density of the composite material is low, this being conducive to the principle of lightweight construction,
the particles are corrosion-resistant,
the particles are commercially available and therefore inexpensive.

Using a polysilazane matrix it is possible to generate an electrically conductive composite material which is sprayable at room temperature and subsequently cures approximately at room temperature.

Advantages of this matrix are as follows:
effective adhesion to an epoxidic substrate,
very good corrosion prevention, since polysilazane itself is used as corrosion prevention,
the matrix is resistant to partial discharge and is temperature-stable,
in conjunction with the ceramic particles, the matrix affords effective protection against abrasion, caused by hail or sand, for example, and against other environmental factors such as brine/sea air/gases.

A surface coating constructed in accordance with the invention may bring about a reduction in resistance in the layer of composite material by several decades, as a result of pyrolysis of different silicon-containing, partially organic matrices, and so the electrical conductivity compares with the pure powder conductivity, measured on a powder ram. The pressure of the powder ram in this case is to be selected such that the compaction and hence the volume packing density coefficient is the same as that of the initial volume introduction into the composite material.

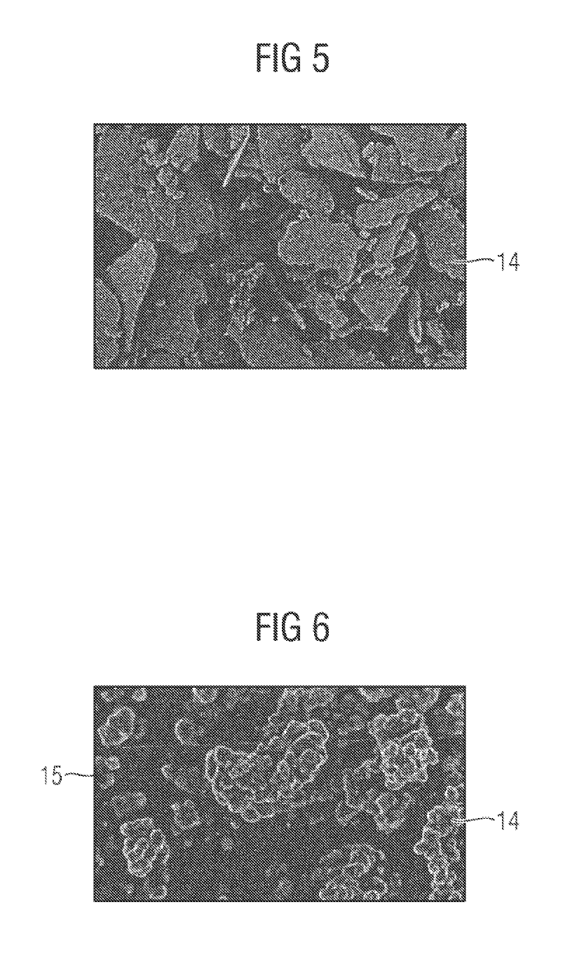

FIG. 5 shows filler particles in lamellar form, preferably on mica substrate. The flakes may consist of superficially of highly conductive, antimony doped SnO2. The use of a filler of this kind significantly lowers the electrical resistance at high field strengths. It has emerged from experiments that the admixture of globular particles to the filler, in accordance with FIG. 6, may contribute to an additional increase in the conductivity of the coating on the filler particles, and hence of the surface coating. Here it is shown that mixtures of spheres and flakes of the same material are more conductive by a decade than the pure particle shapes.

Visible in FIG. 5 is substantially lamellar metal oxide. Depicted in FIG. 6 are both lamellar metal oxide 14 and spherical metal oxide 15. Mica serves in part as substrate, and for the formation of globular particles it is possible with preference to use silicon or silicon oxide. Finely ground quartz in particular is used.

The tin oxide identified in connection with FIGS. 5 and 6 is doped with antimony.

As a matrix, there are a variety of materials that can be used for a lightning protection coating. Theoretically it would be possible to use thermosets such as epoxides, for example, and thermoplastics such as PEEK, PAI, or PEI, for example.

Some embodiments of the invention pertains to polysiloxanes such as, for example, silicone elastomers or silicone resins. The composite material can be applied by brush coating, dip coating, or powder coating.

Through the use of defined metal oxide particles as a highly conductive filler material, it is possible to utilize the optical absorption in certain wavelength ranges of the filler, tin oxide for example, in order to bring about a very high surface temperature as a result of a high irradiation power, infrared irradiation for example. With suitable duration and intensity, pyrolysis is brought about in the composite material layer, with the organic fraction of the matrix being burnt out. The result, given an appropriate matrix formulation, is a stable SiO₂ framework, and can be referred to as ceramic glass. The intensity and duration of irradiation must be adapted to the pyrolysis process and to the layer thickness of the coating, without detriment to the fundamental functionality of the underlying material, such as glass fiber-reinforced plastic with a maximum temperature loading of 155° C., for example.

Through this process it is possible to produce a highly conductive, corrosion-resistant, and water-repellent layer on the surface of organic components with low-temperature stability, without damaging the underlying material, as would be the case, for example, in a complete oven temperature cycle for the curing of the layer.

FIG. 4 shows a record of a measurement on a polysilazane matrix. The temperature 10 is plotted in degrees Celsius on the abscissa. Plotted from left to right on three different ordinates is firstly, on the left, the weight in weight percent 8, secondly the time t with reference numeral 9, and the heat flow 7 on the far right in FIG. 4. The sintering curve itself is represented by the graph 71, heat flow/temperature. The curing 12 and the pyrolysis 13 are each recognizable here as an energy-intensive operation at a defined temperature.

A curve 81 shows the profile of the weight of the surface coating in weight percent as a function of the temperature 10. The curve 101 represents the profile of the temperature as a function of the time.

Since a composite material has been selected for the surface coating, it is necessary first of all to nominate a matrix, which is a polymer. A polysiloxane or a polysilazane is used more particularly. Next, the filler is considered, which in this case is ceramic, composed of a lamellar substrate, as for example mica.

This filler is represented by an electrically conductive metal-oxide coating including or consisting of antimony tin oxide, Sb:SnO2, or antimony doped tin oxide.

The coating here is a partially conductive coating, which within the percolation, with an initial filling of at least 20 vol %, has a high resistance at low field strengths. In combination with this, however, this layer has a very high conductivity at large field strengths as a result of nonlinear behavior of the particle resistance. In a double-logarithmic plot of the voltage/resistance characteristic of a layer of composite material of this kind, the nonlinearity factor α is obtained as the slope of the linear resistance drop with increasing field strength. In this regard, see FIG. 1.

The measurement of the nonlinearity of a layer of composite material including or consisting of a polysilazane matrix with a lamellar filler, the antimony-doped tin oxide, 15 mol % antimony, gives a nonlinearity factor of 3.7. This is in agreement with the measurements of systems which have less doping but are otherwise equivalent. The resulting resistance for a field strength E=550 V/mm under a current density of j=28 A/mm² comes out at ρ=2 Ωcm. Measurement here took place by means of a charge pulse of 55 kV and also 280 A, in order to simulate a real lightning strike. In this case there are local instances of conductive paths developing, but there is no apparent mechanical damage, let alone delamination, of the layer. Accordingly, even at the point of the incoming lightning strike, there is no mechanical damage to the wing beneath. As the process continues, the charge is conducted away radially from the strike point over the entire surface area, resulting in increasingly smaller current densities, and therefore being noncritical.

What is claimed is:

1. A surface coating for lightning conduction comprising an electrically conductive composite material including:
a matrix comprising a polymer, and
a filler disposed within the matrix, the filler comprising lamellar ceramic particles having an electrically conductive, metal-oxide coating.

2. The surface coating of claim 1, wherein the lamellar ceramic particles comprise mica.

3. The surface coating of claim 1 , wherein the electrically conductive, metal-oxide coating of the lamellar ceramic particles comprises a metal-oxide coating that exhibits a nonlinear profile of electrical resistance as a function of electrical field strength.

4. The surface coating of claim 3, wherein the electrically conductive metal-oxide coating comprise an antimony doped tin oxide layer, Sb:SnO2.

5. The surface coating of claim 4, comprise the antimony doped tin oxide layer has a high electrical resistance at small field strengths and a substantially smaller electrical resistance at large field strengths.

6. The surface coating of claim 5, wherein the antimony doped tin oxide layer on the lamellar ceramic particles is filled with at least 10 mol % of antimony.

7. The surface coating of claim 1, wherein the filler comprises a mixture of lamellar and spherical ceramic particles having an antimony doped tin oxide coating.

8. The surface coating of claim 1, wherein the matrix comprises a polysilazane or a polysiloxane.

9. The surface coating of claim 8, wherein the the polysilazane or polysiloxane matrix is free of organic fractions, thereby providing a stable SiN framework or a stable SiO₂ framework.

10. A process for preparing a surface coating comprising an electrically conductive composite material including a matrix comprising a polymer, and a filler disposed within the matrix, the filler comprising lamellar ceramic particles having an electrically conductive, metal-oxide coating, the process comprising:
applying the surface coating in liquid form to a structure,
curing the surface coating, and
performing pyrolysis of the surface coating at short temperature intervals with temperatures up to 700° C., thereby forming a glasslike, temperature-stable, electrically conductive surface coating.

11. The process of claim 10, wherein the antimony doped tin oxide layer of the lamellar ceramic particles is filled with at least 10 mol % of antimony Sb.

12. The lightning protected device of claim 16, wherein the nonmetallic structure comprises rotor blades of a wind power installation.

13. The lightning-protected device of claim 16, wherein the nonmetallic structure comprises surface regions of an aircraft.

14. The lightning-protected device of claim 16, wherein the nonmetallic structure comprises one or more carbon fiber-reinforced components.

15. The lightning-protected device of claim 16, wherein the nonmetallic structure comprises one or more components made of fiber-reinforced plastic.

16. A lightning-protected device, comprising:
a nonmetallic structure,
a surface coating applied to the nonmetallic structure, the surface coating comprising an electrically conductive composite material including:
a matrix comprising a polymer, and
a filler disposed within the matrix, the filler comprising lamellar ceramic particles having an electrically conductive, metal-oxide coating.
